(19) United States
(12) Patent Application Publication
(10) Pub. No.: US 2016/0196723 A1
(43) Pub. Date: Jul. 7, 2016

(54) WAGERING ENTERTAINMENT APPARATUS, SYSTEMS AND METHODS

(71) Applicant: XERAFLOP TECHNOLOGIES INC., Vancouver (CA)

(72) Inventor: Glenn Stacey BALLMAN, Calgary (CA)

(21) Appl. No.: 14/819,250

(22) Filed: Aug. 5, 2015

Related U.S. Application Data
(63) Continuation of application No. PCT/CA2014/050080, filed on Feb. 6, 2014.
(60) Provisional application No. 61/761,594, filed on Feb. 6, 2013.
(60) Provisional application No. 61/761,595, filed on Feb. 6, 2013.

(51) Int. Cl. G07F 17/32

(52) U.S. Cl. CPC G07F 17/3258

(57) ABSTRACT

A method provides a wagering opportunity. The method comprises: providing a plurality of teams, each team comprising one or more team members; providing each team member with a network-enabled wagering interface for making pari-mutuel wagers on outcomes of events; permitting each team member to make one or more qualifying wagers on one or more outcomes of one or more events during a game period; tracking a member-wager-success metric for each team member of each team and a team-wager-success metric for each team, each team-wager-success metric based on a combination of the member-wager-success metrics of its corresponding team members; for each qualifying wager made by each team member during the game period, updating the member-wager-success metric of the team member based on one or more characteristics of the qualifying wager and updating the team-wager-success metric of the team to which the team member belongs based on the updated member-wager-success-metric; and at a conclusion of the game period, awarding incentive awards to the team members of at least one team having a highest team-wager-success metric.

### RELATED APPLICATIONS

This application is a continuation of Patent Cooperation Treaty Application No. PCT/CA2014/050080 filed 6 Feb. 2014 which claims the benefit of the priority of U.S. application No. 61/761,594 filed 6 Feb. 2013 and U.S. application No. 61/761,595 filed 6 Feb. 2013. All of the applications referred to in this paragraph are hereby incorporated herein by reference.

### TECHNICAL FIELD

This application relates to pari-mutuel wagering. Particular embodiments provide apparatus, systems and methods for promoting and/or placing pari-mutuel wagers.

### BACKGROUND

A common form of gambling involves a so-called “pari-mutuel” system, where: all wagers of a particular type are placed together in a pool; taxes and a “house-take” (or commission) are removed from the pool; and the remaining amount of the pool is then paid out to the winners. Together, the house take and taxes (and any other amounts removed from the pool prior to payout) may be referred to as the “takeout”. Unlike fixed-odds wagering (where the odds of a wager are known in advance), pari-mutuel wagering involves calculating the payoff odds after the pool is closed (and after removal of the takeout). Pari-mutuel wagering is common in horse racing and greyhound racing, although it is not limited to these types of wagering.

In a simplified example of pari-mutuel wagering, consider a horse race involving eight horses where the only type of wager is a win wager—i.e. a wager on the horse that will place first in the race. Such a race has eight possible outcomes—i.e. each of the eight horses could win. Assume that at the time betting closes (e.g. right before the race), the wagers on the various horses to win were as shown in Table 1 below.

TABLE 1
Example Pari-mutuel Horse Race

| Horse to Win | Wager Amounts |
|---|---|
| 1 | $500 |
| 2 | $150 |
| 3 | $200 |
| 4 | $125 |
| 5 | $275 |
| 6 | $200 |
| 7 | $350 |
| 8 | $150 |

In the Table 1 example, the total pool of money (often referred to as the “handle”) is the sum of the amounts in the second column—i.e. $1950. Assuming that the takeout rate is 20%, the pool will be reduced by 0.20*$1950=$390, leaving total available winnings of $1950-$390=$1560. Now assume that the winning horse was horse number 6. So the remaining pool is distributed to those who wagered on horse number 6 in the amount of $1560/$200≈7.80 for every $1 wagered. Since this $7.80 payout includes the original $1 wagered, the actual profit from a $1 wager on horse number 6 is $6.80 and the odds of a bet placed on horse number 6 are 6.8 to 1 (fractional odds) or $7.80 (decimal odds).

Based on the above example, it will be appreciated that the exact odds of a particular wager are subject to change while wagers are still being accepted on the race. However, the odds at any particular instant in time may be calculated. These instantaneous odds are only approximate, because in the time required for calculation, additional wagers may be placed, thereby changing the odds. For example, in the case of the Table 1 example at the instant that the Table 1 wagers are accurate, the approximate fractional odds for the Table 1 event may be calculated as shown in Table 2.

TABLE 1
Example Instantaneous Odds for Table 1 Race

| | Payout Odds |
|---|---|
| Horse to Win | (Fractional) |
| 1 | $2.12/1 |
| 2 | $9.4/1 |
| 3 | $6.8/1 |
| 4 | $11.5/1 |
| 5 | $4.7/1 |
| 6 | $6.8/1 |
| 7 | $3.6/1 |
| 8 | $9.4/1 |

The ability to calculate approximate instantaneous odds on horse races and greyhound races led to the development of devices known as “totalizators” or, more commonly, “totes”. In their most basic form, totes can calculate the approximate instantaneous payoff odds of a race. The development of totes has led to a corresponding proliferation of “off-track” betting (also known as “OTB”) facilities where wagers can be placed on race events from locations away from the racing track. Modern totes comprise computers running specialized software (e.g. Autotote™ or the like). Modern totes are networked to be able to communicate with one another from distributed OTB locations and to thereby obtain approximate instantaneous odds which account for wagers placed from other OTB locations. Modern totes can also accept wagers and issue corresponding tickets which evidence the wagers placed. Typically, a bettor would communicate their wager to a teller at an OTB, who would take the bettors money, enter the wager into the tote and issue a corresponding ticket.

Current OTB facilities have a number of drawbacks which can make it undesirable for bettors to place wagers at an OTB. By way of non-limiting example: OTBs receive satellite video feeds from various racetracks, but have a limited number of video screens, which can create a drawback for bettors when they cannot locate a display screen which is showing a race on which they wagered or when races from various tracks are temporally overlapping; typically, at an OTB, sound must be turned off on all of the displays, because there is no correspondence between bettors and displays and there are many displays in which various users may or may not be interested; odds received by satellite and displayed on video screens can be delayed by several seconds over instantaneous odds; a bettor may have to leave their seat to interact with a teller each time that they make a bet or to view a race on a display screen that may be at another location in the facility; wagers are generally placed anonymously which can preclude the ability to customize the entertainment experience and/or others. The payback to the OTB operators comes from the takeout associated with wagers placed at their OTB facilities. Consequently, if bettors are not betting at an OTB facility, the income of the OTB operator will be correspondingly reduced.

There is a general desire to improve the OTB wagering experience for bettors, for OTB operators and/or for other parties involved in pari-mutuel gambling events, such as horse races, greyhound races and/or the like.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention provide systems, methods and/or apparatus for wagering at an “off track” betting (OTB) facility which provide an entertainment experience that is customized for a particular user or group of users.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A and 1B (collectively, FIG. 1) are isometric views of a wagering apparatus 10 according to a particular embodiment with its cabinet door closed (FIG. 1A) and its cabinet door open (FIG. 1B).

FIG. 2 is a schematic view of a number of the functional components of the FIG. 1 apparatus.

FIG. 3 is a schematic illustration of an entertainment system according to a particular embodiment which incorporates the FIG. 1 apparatus.

FIG. 4 is a schematic illustration of an account system which may be used in connection with the FIG. 1 apparatus and the FIG. 3 system.

FIG. 5 shows a schematic depiction of a method for implementing a team-based wagering opportunity according to a particular embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

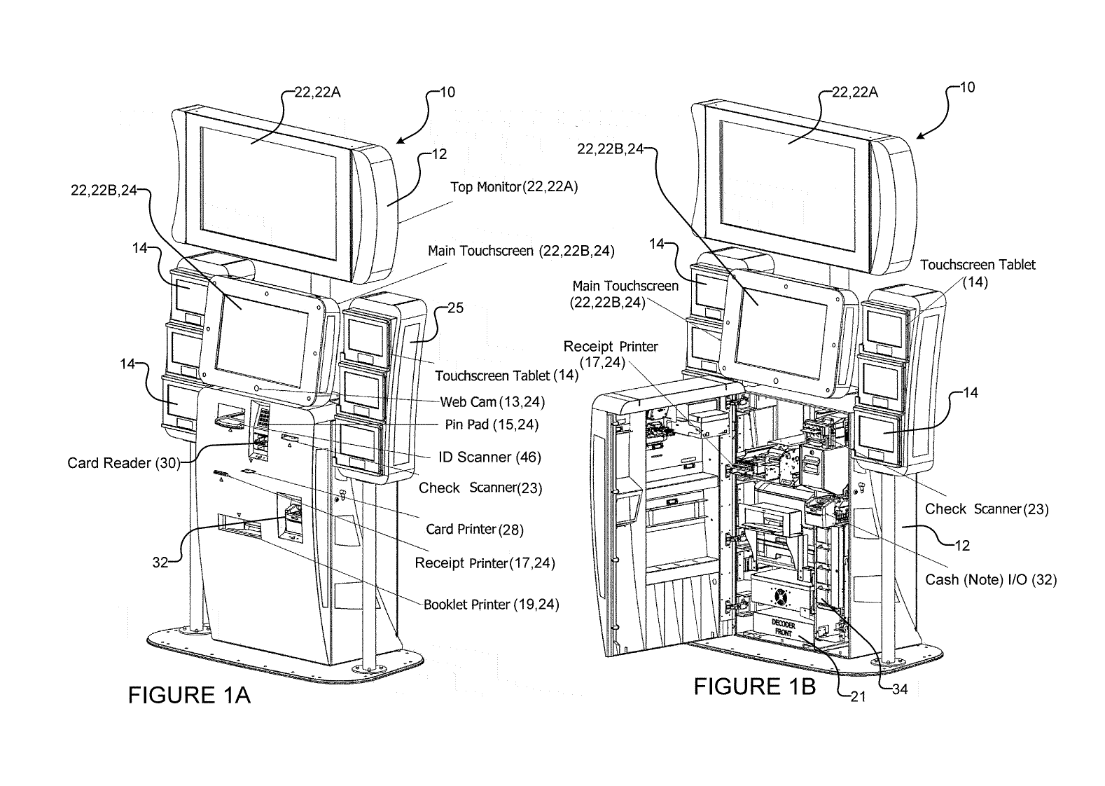

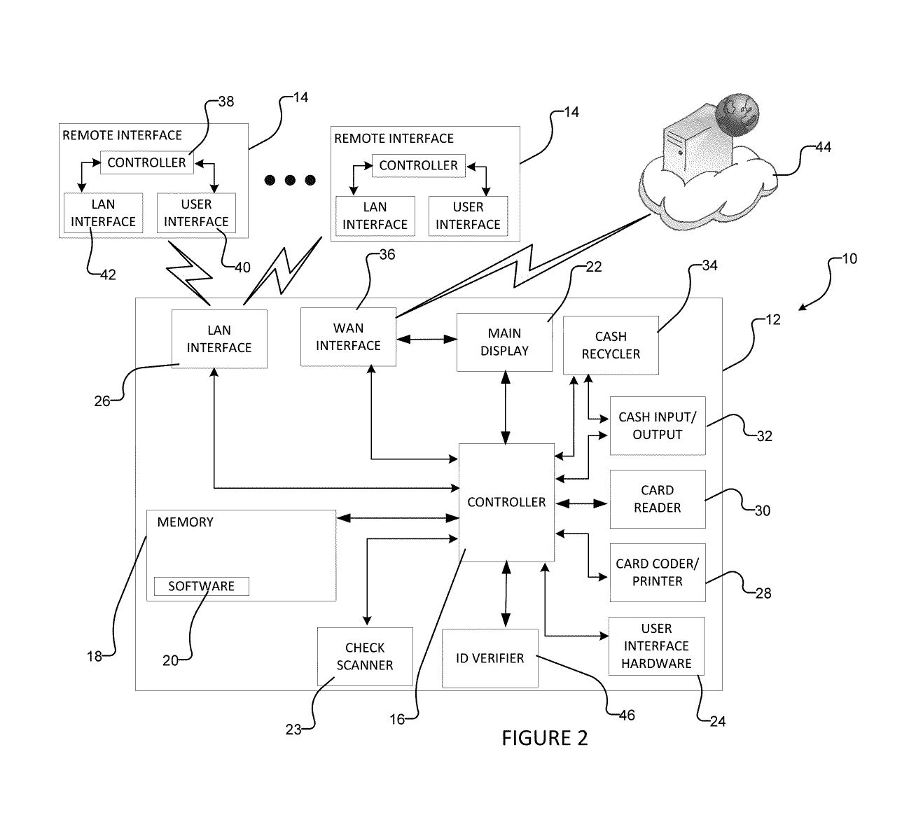

FIG. 1 is an isometric view of a wagering apparatus 10 according to a particular embodiment. FIG. 2 is a schematic view showing the functional components of wagering apparatus 10. Wagering apparatus 10 comprises a main wagering apparatus 12 and, optionally, one or more remote interface units 14. Wagering apparatus 12 is controlled by a controller 16. Controller 16 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 16 may have access to software instructions 20 which may be stored in computer-readable memory 18 accessible to controller 16 and/or in computer-readable memory (not shown) that is integral to controller 16. Controller 16 may be configured to read and execute software instructions 20 and, when executed by controller 16, such software 20 may cause controller 16 to implement one or more of the methods described herein.

Controller 16 may interact with and control a number of the other functional components of wagering apparatus 12. More particularly, controller 16 may control a display 22 and other user interface hardware 24 for interacting with user(s)/bettor(s). Display 22 and/or user interface hardware 24 may be used (by controller 16) to implement a graphical user interface (GUI). By way of non-limiting example, display 22 may comprise a video display which may optionally have “touch screen” functionality for accepting user input (e.g. by tapping a screen of display 22 and/or using other gestures where a user contacts the screen with their body, with a suitably configured stylus and/or the like). In the FIG. 1 embodiment, display 22 incorporates a two-part display 22 which comprises a large-screen display 22A and a touch-screen display 22B. Because of its touch-screen capability, touch-screen display 22B also provides part of user interface hardware 24. By way of non-limiting example, other user interface hardware 24 may comprise a keypad, a keyboard, a selector device (e.g. a mouse, trackpad or similar pointing device) and/or the like. In the FIG. 1 embodiment, user interface hardware 24 comprises touch-screen display 22B, camera 13, keypad 15, receipt printer 17 and booklet (e.g. race information) printer 19. In some embodiments, user interface hardware 24 may comprise fewer components, additional components or other components suitable for interacting with a user in the manner described herein. In addition to its functionality for implementing the GUI, display 22 (e.g. one or both of large-screen display 22A and touch-screen display 22B) may also be used to display satellite feeds (e.g. of horse race events or the like) and/or signals which may be received from network 44 via wide area network (WAN) interface 36. Such video signals may be decoded (e.g. by decoder 21) for display on display 22. In some embodiments, main apparatus 12 comprises a plurality of large-screen displays 22A. In some embodiments, main apparatus 12 is in direct or indirect communication with other external displays (not shown) for rendering video content.

In the illustrated embodiment, wagering apparatus 12 comprises LAN interface 26 for communication with a local area network (e.g. a local network comprising main apparatus 12, remote interface units 14 and/or other suitable devices) and a wide area network (WAN) interface 36 for interacting with a WAN network 44, such as the internet or the like. More particularly and as explained in more detail below, controller 16 can communicate (via WAN interface 36) through the internet 44 to place wagers on various races (or other pari-mutuel wagering events), to connect to live video feeds of various races, to interact with stored value accounts of various users and/or the like. In some embodiments, wagering apparatus 10 and/or the venue in which main wagering apparatus 12 is deployed may comprise a WAN interface 36 (e.g. a suitable router and internet access point) that is not provided as a part of main wagering apparatus 12, but rather is separate from main wagering apparatus 12. In such embodiments, main wagering apparatus 12 may communicate with WAN network 44 via LAN interface 26 and the external WAN interface 36.

Wagering apparatus 12 may also comprise other hardware which may be controlled by controller 16 for interacting with user(s). In the illustrated embodiment, such user-interaction hardware comprises a card coder/printer 28, a card reader 30, a cash input/output 32, an identification verification unit 46 and a check scanner 23. In some embodiments, wagering apparatus 12 may comprise additional or alternative user-interaction hardware. In some embodiments, wagering apparatus 12 may not contain all of card coder/printer 28, card reader 30, cash input/output 32, identification verification unit 46 and check scanner 23.

Card coder/printer 28 may be used to encode information on user-ID cards. Examples of information that can be encoded onto a card by card coder/printer 28 include a user account ID, which enables a user to create, access and otherwise interact with a stored value account. Such stored value accounts may comprise online stored value accounts provided by third party services and may be accessed via WAN interface 36 and network 44 (e.g. the internet). Such stored value accounts enable secure money transfers (e.g. electronic funds transfers (EFT), automated clearing house (ACH) transfers and/or the like) via network 44. In some embodiments, a user-ID card is not necessary for a user to interact with their stored value account via wagering apparatus 10. For example, a user may manually enter a user ID and password using user interface hardware 24 to interact with their stored value account via wagering apparatus 10. In some embodiments, a user may additionally or alternatively enter a user ID and password (or other suitable login criteria) using a remote interface unit 14 (described in more detail below). Wagering apparatus 10 (under the control of controller 16) is configured to accept wagers by withdrawing money from stored value accounts accessed by users via WAN interface 36 and network 44. In some embodiments, card coder/printer 28 could additionally or alternatively be used to encode an indication of the amount of stored value in an account associated with a corresponding card, such that a user's card may act in a manner similar to stored value card or credit card. In some embodiments, card coder/printer 28 may additionally be able to read information that it (or other similar card encoder/printers) have encoded onto users' cards.

Cash input/output 32 may be used to accept cash from user(s) as input and to output cash to user(s) as output. For example, cash received via cash input 32 may be deposited (via WAN interface 36 and network 44) into a user's online stored value account and subsequently used for wagering. Additionally or alternatively, cash received via cash input 32 may be directly used for wagering. Cash received into apparatus 12 via cash input/output 32 can be provided to cash recycler 34. Cash recycler 34 may scan received cash to determine the denominations of received notes and (optionally) their serial numbers. Cash recycler 34 may also sort the various different note denominations for storage into corresponding receptacles. If a user wins, their winnings may be deposited (via WAN interface 36 and network 44) into their online stored value account. If the user chooses to receive cash winnings, then the user may make this indication known to apparatus 10 (e.g. via user interface hardware 24) and controller 16 may cause a withdrawal from the user's online stored value account and cause cash to be output from apparatus 10 (i.e. from cash recycler 34) via cash input/output 32.

Card reader 30 may be capable of reading credit cards, bank cards and/or the like and, with the possible assistance of controller 16, conducting transactions involving such cards (e.g. via WAN interface 36 and network 44). For example, card reader 30 may be able to withdraw an amount from a user's credit/debit card and to deposit a corresponding amount into a user's stored value account. Similarly, in some embodiments, card reader 30 may be able to withdraw an amount from a user's stored value account and to deposit a corresponding amount onto a user's credit/debit card. In some embodiments, card reader 30 also functions to read the cards encoded by card encoder/printer 28. In some embodiments, card encoder/printer 28, check scanner 23 and/or cash input/output 32 may also function as a card reader 30.

In some embodiments (e.g. where required in a particular jurisdiction or otherwise desirable), identification verifier 46 can be used to verify the identity of a user. By way of non-limiting example, identification verifier 46 may scan a piece of a user's identification and may use the scanned image to verify the user's age. In some embodiments, identification verifier 46 can include components for verifying the legitimacy of a piece of identification. For example, identification verifier 46 can include optical components (and suitable hardware and software configuration) for determining the type of plastic or paper used in a piece of identification and/or for locating authentication indicia to verify that the piece of identification is legitimate. In some embodiments, identification verifier 46 may comprise a camera 13, which may record an image of the user's face. This image may be saved in association with the user's account (e.g. for security procedures, auditing records and/or the like) and may be used as part of the identification verification procedure (e.g. using suitable facial recognition software and/or the like).

In the illustrated embodiment, apparatus 10 also includes an optional check scanner 23. Check scanner 23 may permit apparatus 10 to receive payment in the form of checks and may facilitate so-called “daylight loans” or the like where third party checks made out to a user may be received as input funds. Check scanner 23 may include suitable security and/or verification components for verifying the legitimacy of received checks.

In the illustrated embodiment, apparatus 10 comprises additional lights 25 which may be used to attract potential users to apparatus 10. To attract potential users, apparatus 10 may also play back audio and/or video associated with events (e.g. horse races) on which pari-mutuel wagers may be placed. Such video/audio may be shown/played back on display 22, on remote interface units 14, and/or on other displays or devices (e.g. on television screens in a bar). For example, apparatus 10 may show video and/or playback audio with shouting jockeys, pounding hooves, cheering fans and the like

Apparatus 10 may be installed in a traditional OTB venue, such as a casino and/or the like, for example. Apparatus 10 may additionally or alternatively be installed in a social or entertainment venue (such as a bar, restaurant, or the like), and/or any other suitable venue, including those which have social and/or entertainment facilities other than merely wagering. For the remainder of this description, it will be assumed, without loss of generality, that wagering apparatus 10 is located in a bar.

In operation, a patron of the bar may decide that they could have some fun if they placed a wager on a horse race (or other pari-mutuel event) via wagering apparatus 10. The first time that a user without an existing stored value account interacts with apparatus 10, the user may interact with apparatus 10 (via user interface hardware 24) to create a stored value account. Creation of the stored value account may optionally involve the user presenting their identification to be verified by identification verifier 46. Alternatively, or in addition, the user may create a stored value account online prior to (or while) interacting with apparatus 10. Once the account is created, card coder/printer 28 may create a user account ID card for the user which may be output to the user at that time. If the user created an account online, they may receive a user account ID card when they first log in to apparatus 10. The user can then fund the account using a credit/debit card (or the like) inserted into card reader 30, cash inserted into cash input/output 32, a check inserted into check scanner 23, online fund transfer, and/or the like. In some embodiments, users can fund their accounts with the human employees of the venue in which apparatus 10 is located, who may use a different system (not shown) to record the funding of the user's account (e.g. to increase the available balance of the user's stored value account). Once the account is created and funded, the user is in a position to place a wager.

It will be appreciated that creating a stored value account may only be required the first time that a user who has not previously created an account interacts with apparatus 10. A user may create a stored value account on one apparatus 10 and then place wagers using a different apparatus 10 and/or a remote interface unit 14 which may be at the same venue or at a different venue. The second and subsequent time(s) that a user interacts with apparatus 10 (or a similar apparatus 10 or a remote interface unit 14), the user may be able to use their user ID card (via card reader 30 or card coder/printer 28) to login to their account or may otherwise login to their account via user interface hardware 24 (or user interface 40 of remote interface unit 14), for example by providing a username and password. Provided that the account is funded, the user will be in a position to place a wager after logging in to their existing account. Depending on any local regulatory requirements, in some embodiments, a user may be required to verify their identification (via identification verifier 46) each time that they interact with apparatus 10.

In some embodiments, it may be desirable to provide multiple levels of stored value accounts. For example, some credit/debit card companies (or similar financial institutions) do not permit use of their cards directly for wagering. In such cases, a user may create a first “gift card” stored value account which can be funded as discussed above (but which is not used directly for wagering) and then a second “wagering” stored value account which can be funded indirectly with funds from the first gift card stored value account (and which can be used directly for wagering).

The GUI of apparatus 12 may enable and optionally guide the user to select the particulars of a wager. In the case of a horse race, greyhound race or the like, such wager particulars, may include without limitation: the track at which the race is being run, the particular race at the track, the amount of the wager and the type of the wager. As is well known to those familiar with horse racing, there are a large variety of bet types. Such bet types include: single race bets, such as (without limitation): win, place, show, exacta, trifecta, superfecta, duet and/or the like; and multi-race bets, such as (without limitation): double, triple, quadrella, sweep and/or the like. The GUI of apparatus 12 may display information (e.g. textually, audibly and/or graphically) about various races and/or wagers, handicapping strategies and/or the like. By way of non-limiting example, such information could include: constantly increasing pool sizes, instantaneous approximate odds, risk levels against payout potential, reports indicating the user's handicapping rates of success, statistical tools and tips to help the user become a better handicapper, information that might be useful to help a user identify handicapping opportunities that meet their user-specific handicapping criteria and/or the like.

When the user submits their wager, the amount of the wager is withdrawn from their stored value account and recorded by apparatus 10 (e.g. by controller 16). These wagered amounts may then become the property of the “house”—e.g. the proprietor of wagering apparatus 10, the proprietor of the venue in which apparatus 10 is located and/or the like. To the extent that the house does not administer the stored value account service, there may be a need for reconciliation between the accounts of the house and the stored value account service so that the stored value account service can pay the wagered amounts to the house. Additionally or alternatively, the house may maintain an account with the stored value account service into which wagered amounts may be credited. This reconciliation can happen in real time (e.g. as soon as the wagered amounts are debited from the user's stored value account) or at discrete times (e.g. daily, weekly or monthly). From time to time (e.g. daily, weekly or monthly) a pari-mutuel wagering oversight body (e.g. CHRIMS Inc. and/or the like) may request payment of these wagered amounts from the house and these wagered amounts will be transferred from the house to the oversight body. Such transfers may be effected by EFT, ACH transfer and/or the like. In some embodiments, such transfers from the house to the oversight body may happen in real time. From time to time (e.g. daily, weekly or monthly), the oversight body may then remit these wagered funds to the various stakeholders (e.g. race tracks, government bodies, content providers, winners and/or the like) in the form of takeout or winnings. In some embodiments, such transfers from the oversight body to the various stakeholders may happen in real time.

When the user submits their wager, controller 16 may access a video feed (via satellite, via network 44 or otherwise) to display the corresponding race(s) on display 22. In some embodiments, wagering apparatus 10 can be in communication with one or more other displays (not shown) in the bar in which apparatus 10 is located. In such embodiments, controller 16 may cause the video feed of the race(s) on which the user has wagered to be displayed on one or more of such other display(s). Controller 16 may be configured to cause display 22 (or some other aspect of its user interface) to direct the user to one of one or more other displays that are displaying or will display the race(s) on which the user has wagered. Additionally or alternatively, controller 16 may allow a user to select (via user interface hardware 24) one or more available displays on which to display such race(s). For example, controller 16 may direct a television near the user's table to display a race on which the user has wagered. Still other techniques may be used to select display(s) on which the race(s) that a user has wagered may be displayed.

If the race is run and the user loses, then no funds are deposited in the user's stored value account in respect of the lost wager. If the user wins, controller 16 records the user's winnings and makes the winnings available in the user's stored value account. Such winnings may be paid by the house. To the extent that the house does not administer the user's stored value account service, there may be a need for reconciliation between the accounts of the house and the stored value account service, so that the house can pay the winnings to the stored value account service. Additionally or alternatively, the house may maintain an account with the stored value account service which can be debited to pay the winnings to the stored value account service. This reconciliation can happen in real time (e.g. as soon as the winnings are placed into the user's stored value account) or at discrete times (e.g. daily, weekly or monthly). As mentioned above, from time to time (e.g. daily, weekly or monthly), an oversight body may transfer to the house its share of the takeout based on wagers placed through the house together with any winnings on wagers placed through the house.

If a user wants to cash out, they can withdraw the funds from their stored value account. Otherwise, some or all of the funds can be left in the account for subsequent wagering. Cash may be withdrawn, for example, from cash input/output 32 and/or from the house (e.g. by receiving cash from an employee who then debits the user's stored value account). Withdrawal of funds may also, or alternatively, occur via online fund transfer, deposit onto a debit/credit card, issuance of a check, or by other means.

In the illustrated embodiment, wagering apparatus 10 comprises one or more optional remote interface units 14. Remote interface units 14 provide some of the functionality of main apparatus 12 and permit users to interact with wagering apparatus 10 to place wagers from remote locations (e.g. from their tables at a bar). Remote interface units 14 may be implemented, for example, by suitably configured tablet computing devices, suitably configured touch screen computing devices, suitably configured mobile phones and/or the like. In the illustrated embodiment, remote interface devices 14 are provided by the house. This is not necessary, however. In some embodiments, remote interface devices 14 may be embodied by the user's own device—e.g. suitably configured tablet computing devices, mobile phones and/or the like which may run suitable software application(s) and/or access suitable website(s). Each remote interface unit 14 comprises its own controller 38. Controller 38 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 38 may have access to software instructions (not shown) which may be stored in computer-readable memory (not shown) accessible to, and/or integral to, controller 38. In some embodiments, controller 38 may have access to software instructions 20 stored by main apparatus 12. Controller 38 may be configured to read and execute such software instructions to thereby implement one or more of the methods described herein.

Remote interface unit 14 comprises a user interface 40 which may include a display and suitable user input devices (e.g. a touch screen display, a keyboard, a pointing device and/or the like) to provide a graphical user interface (GUI). The GUI and display of remote interface unit 14 may be similar to the GUI and display 22 of main apparatus 12 and may provide the same or similar functionality. In the illustrated embodiment, remote interface unit 14 comprises a local area network (LAN) interface 42 for communication with main apparatus 12 (via a corresponding LAN interface 26 in main apparatus 12) and/or with other remote interface units 14 (e.g. to send messages between users of remote interface units 14). Remote interface unit 14 may communicate with WAN 44 (e.g. the internet) via the WAN interface 36 of apparatus 10. In some embodiments, remote interface unit 14 may additionally or alternatively comprise a WAN interface of its own (not shown) for communication to WAN 44 (e.g. the internet). A user can use remote interface unit 14 to place wagers and/or to perform other functions, such as (for example) streaming video of a race on which the user has wagered, performing account management, transferring funds, and so on. Such wagers may be communicated from remote interface unit 14 to main apparatus 12 through LAN interfaces 42, 26, whereafter it can be treated by main apparatus 12 like any other wager described herein, or, if remote interface unit 14 has its own WAN interface such wager may be placed directly via WAN 44 by remote interface unit 14. As discussed above, in some embodiments WAN interface 36 is not a part of main apparatus 12, but is instead an external WAN interface 36 (e.g. a suitable router and wireless access point). In such embodiments, remote interface units 14 can interact with WAN 44 (independently of main apparatus 12) to place wagers and/or to provide other functionality similar to that of apparatus 12 described herein. Video feeds (e.g. satellite or internet) procured by main apparatus 12 can also be communicated to remote interface unit 14 via LAN interfaces 26, 42 or may be procured directly by remote interface unit 14 from WAN 44.

A user may be able to login to their stored value accounts via remote interface unit 14 using user interface 40. In some embodiments, a user ID card or identification verification may be required for a user to login; in such embodiments, a user may need to login at main apparatus 12. A user may login to main apparatus 12 to “sign out” (e.g. acquire temporary use or possession of) a remote interface unit 14. In some embodiments, users can “sign out” a remote interface unit 14 from human employees of the venue in which apparatus 10 is located. Similarly, a user may (but need not necessarily) interact with main apparatus 12 to fund their account via cash input/output 32 or card reader 30 before signing out and using remote interface unit 14. In some embodiments, users can fund their accounts directly using remote interface units 14 and/or with the human employees of the venue in which apparatus 10 is located, who may use a different system (not shown) to record the funding of the user's account. A user may login to apparatus 10 at main apparatus 12 prior to signing out a remote interface unit 14 and/or on remote interface unit 14 after unit 14 is signed out. Once signed out, a user may interact with remote interface unit 14 which may provide functionality similar to that of main apparatus 12 described herein.

As shown in FIG. 1, prior to being signed out, remote interface units 14 may be mounted to main apparatus 12. Remote interface units 14 may be locked to main apparatus 12 by suitable electrically controlled locking mechanisms (not shown), such as solenoid-actuated locks and/or the like. Controller 16 may cause a remote interface unit 14 to be unlocked when it is properly signed out by a user. A deposit may be collected from (or held in) the user's account to encourage the user to return remote interface unit 14. In some embodiments, remote interface units 14 may comprise proximity sensors, GPS sensors, RFID tags and/or the like which may activate alarms if the remote interface units 14 is moved too far from main apparatus 12.

In some embodiments, remote interface units 14 may rented (e.g. by the hour or by the minute). In such embodiments, main apparatus 12 may be configured to detect (e.g. with suitable detectors or the like and/or suitable interaction via LAN interfaces 26, 42) when a remote interface unit 14 is removed from its mount on apparatus 12 and when the remote interface unit 14 is returned to its mount. The user's stored value account may then be debited according to the amount of time that remote interface unit 14 was away from its mount. The user's deposit may also be returned (or freed) when remote interface unit is detected as being returned. In some embodiments, remote interface units 14 may be “docked” to suitable mounts at locations away from main apparatus 12—e.g. at mounts located on tables, on bar tops, on the floor in front of a large screen display and/or the like. In some such embodiments, remote interface units 14 may be activated when they are docked to such mounts and de-activated otherwise.

In some embodiments, main apparatus 12 is not necessary and apparatus 10 (and corresponding systems and methods) may be implemented using only remote interface units 14. In some such embodiments, remote interface units 14 may be provided with some of the hardware and/or functionality of main apparatus 12. By way of non-limiting example, remote interface units 14 may be provided with card readers similar to card reader 30 described above to permit a user to fund their account using remote interface unit 14. In some embodiments that comprise only remote interface units 14, some functionalities of main apparatus 12 that are not provided directly by remote interface units 14 may be provided in part by other systems and/or by employees of the venue in which apparatus 10 is located. Employees may use other systems (not shown) to implement these functionalities. By way of non-limiting example, a user may fund their account by providing cash (or their credit/debit card) to an employee who may use an external system to verify the user's credit/debit card and to record the deposit into the user's account. In some embodiments which comprise only remote interface units 14, some of the hardware of main apparatus 12 may be separately provided and shared by remote interface units 14. By way of non-limiting example, as discussed above, WAN interface 36 may be separate from main apparatus 12 and may be shared by remote interface units 14. As another non-limiting example, ID verifier 46, card reader 30, card coder/printer 28 and/or the like could be provided in a stand-alone unit separate from main apparatus 12 and could be used in an embodiment having only remote interface units 14.

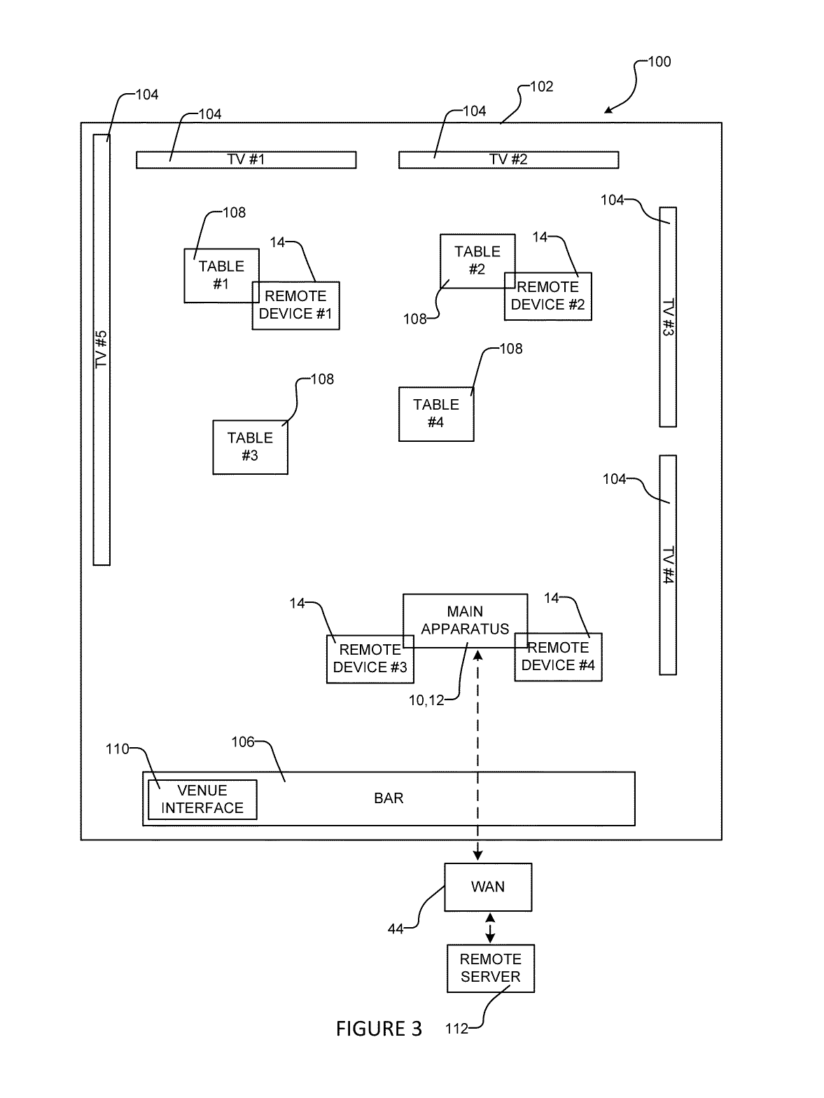

In some embodiments, apparatus 10 may provide part of a comprehensive entertainment system. FIG. 3 is a schematic illustration of an entertainment system 100 according to a particular embodiment that incorporates apparatus 10. Entertainment system 100 of the illustrated embodiment is provided in a venue 102, which could be any suitable venue, such as a more traditional OTB facility, a bar, a casino, an airport waiting area and/or the like. In the example illustration of FIG. 3, venue 102 includes a bar 106 and a number of tables 108. Entertainment system 100 comprises apparatus 10 (including main apparatus 12 and a number of remote interface units 14), a number of displays (e.g. televisions) 104, a venue interface 110, a remote server 112 which is accessible to apparatus 10 (both main apparatus 12 and remote interface units 14) via WAN 44. In the example illustration of FIG. 3, remote interface unit #1 is being used by the patrons sitting at table #1 and remote interface unit #2 is being used by the patrons sitting at table #2. Remote interface units #3 and #4 are not being used and are attached to main apparatus 12.

Entertainment system 100 facilitates control of displays 104. More particularly, displays 104 can be advantageously controlled by main apparatus 12, remote interface units 14, venue interface 110 and/or remote server 112. Displays 104 may be provided with LAN interfaces, WAN interfaces or other communications interfaces (not expressly shown) for communicating with various networked devices (e.g. main apparatus 12, remote interface units 14, venue interface 110 and/or remote server 112). Displays 104 may be equipped to display signals coming from satellite feeds, from WAN 44 (e.g. remote server 112) and/or other video sources. Displays 104 may be configured to identify themselves (e.g. by displaying TV #1, TV #2 . . . ) permanently, on startup and/or in response to interrogation from main apparatus 12, remote interface units 14, venue interface 110 and/or remote server 112.

In some embodiments, a user using main apparatus 12 and/or one of remote interface units 14 can cause a particular display 104 to display particular content—e.g. a race on which the user has wagered. For example, the user at table #2 is relatively close to TV #2 and TV #3. Consequently, the user at table #2 might want to see races on which they wagered at one of TV #2 or TV #3. System 100 may permit this user at table #2 to control TV #2 and/or TV #3, for example by using the remote interface unit #2 and/or by signing out a TV at main apparatus 12. In some embodiments, one or more of displays 104 and remote interface units 14 may comprise proximity sensors or the like for detecting which remote interface unit 14 is closest to which display 104. In such embodiments, system 100 may automatically select the race(s) corresponding to wagers placed on the closest pairs of displays 104 and remote interface units 14. For example, remote interface unit #1 is relatively close to TV#1 and remote interface unit #2 is relatively close to TV#2, so system 100 may automatically elect to display race(s) corresponding to the wagers place on remote interface #1 on TV#1 and the race(s) corresponding to the wagers placed on remote interface #2 on TV #2.

In some scenarios, multiple users may wish to see different races on the same display 104 at the same time (e.g. if there are more users than displays 104, if a particular display 104 is especially desirable, etc.). Apparatus 10 may resolve such conflicts by maintaining a schedule for each display 104, allowing users to schedule viewing times on a first-come-first-served basis. In some embodiments, such conflicts between users over control of a display 104 may be resolved based on one or more other criteria include, by way of non-limiting example: the users' relative frequency of use of remote interface units 14 or main apparatus 12 to make wagers and/or other purchases (e.g. from venue 102), which may include one or both of frequency of wagers and/or purchases made in the user's current visit to venue 102 and frequency of wagers and/or purchases made over historical visits to venue 102 (e.g. over a configurable or predetermined historical temporal window); the users' relative amounts spent on wagering and/or making purchases (e.g. from venue 102) using remote interface units 14 or main apparatus 12, which may include one or both of amounts spent in the user's current visit to venue 102 and amounts spent over historical visits to venue 102 (e.g. over a configurable or predetermined historical temporal window); the users' relative winnings from wagers placed using remote interface units 14 or main apparatus 12; the relative amounts of the users' current wagers (i.e. on a race that is currently being broadcast or is about to be broadcast); and/or the like. Still other additional or alternative exemplary criteria for resolving such conflicts include: apparatus 10 may give preference to certain users on the basis of points (or the like) in loyalty or reward system, whether or not one or more of the users in conflict have signed out or otherwise possess streaming-capable remote interface units 14, the number of users who have selected a particular race, and/or on other bases. Once a display 104 has been allocated to a particular user or group of users, apparatus 10 may allow the user(s) to control one or more settings of the display 104, and/or apparatus 10 may automatically direct the display 104 to the appropriate race with or without permitting additional control by the user(s).

Using main apparatus 12 and/or one of remote interface units 14, users may have the ability to control other settings of the displays 104, such as their volume, brightness, contrast etc. Using main apparatus 12 and/or one of remote interface units 14, users may also have the ability to send messages to a display 104 under their control, to other displays 104 in system 100 and/or to other ones of main apparatus 12 and remote interface units 14. In some embodiments, system 100 may permit such messaging using other LAN-enabled or WAN-enabled devices (not shown), such as a mobile telephone or the like. As discussed above, displays 104 may be configured to identify themselves (e.g. by displaying TV #1, TV #2 . . . ) in response to interrogation from main apparatus 12 and/or one of remote interface units 14, so that a user can be sure that they are controlling the correct one of displays 104.

In some embodiments, remote interface units 14 or main apparatus 12 which are controlling displays 104 can determine if a display loses a satellite or internet video signal (e.g. of an event that a user is viewing) and can switch from the lost signal to a backup signal (e.g. via satellite or internet). In some embodiments, this functionality may be provided in displays 104 themselves, whether or not they are under the control of one of remote interface units 14 or main apparatus 12.

In some embodiments, remote interface units 14 can determine where they are in venue 102 (at least relative to displays 104 in bar 102) and can offer the selection of particular displays 104 to control based on their proximity to such displays 104. For example, remote interface unit #2 is relatively close to TV#2 and TV #3 and may offer the users at table #2 the ability to control TV#2 and/or TV #3. Remote interface units 14 may comprise GPS receivers or the like which can enable remote interface units 14 to detect their location. Additionally or alternatively, remote interface units 14 may comprise suitable proximity sensors to detect which displays 104 are located within a proximity threshold (e.g. via RFID, Bluetooth™, and/or other means). In some embodiments, remote interface units 14 which can determine their location in venue 102 may provide a “moving map” functionality which shows the locations of the various displays 104 in venue 102.

Venue interface 110 may be provided with LAN interfaces, WAN interfaces or other communications interfaces (not expressly shown) for communicating with displays 104, remote interface units 114 and/or main apparatus 12. In some embodiments, the proprietor of venue 102 can use venue interface 110 to take control of the signals to any or all of displays 104 for a desired period of time and may lock out user-control of some or all displays 104 via remote interface units 14 or main apparatus 12. For example, the proprietor of venue 102 may want to switch a number of particular displays 104 (or all of displays 104) to watch a particular event (e.g. a particular high-profile race or playoff sporting event). The proprietor of venue 102 may want to control the maximum volume level of any or all of displays 104.

Venue interface 110 may also permit the proprietor of venue 102 to send out targeted messages to particular displays 104, to particular remote interface units 14 and/or to main apparatus 12. By way of non-limiting example, such targeted messages may contain text, sound, graphics video, advertising, winning results, team results, other statistics and/or the like. Messages may be sent to particular displays 104, particular remote interface units 14 and/or to main apparatus 12 based on user activity information. In one particular example, every 30 minutes for which a user has been interacting with a particular remote interface unit 14 or right after the user of a particular remote interface unit 14 wins a wager, venue interface 110 may send an advertisement for drinks (or any other goods/services offered by venue 102 or any other goods/services offered by third parties) to the remote interface unit 14 (or to a display 104 under the control of the remote interface unit 14) and may offer the user the ability to purchase the goods/services using remote interface unit 14 (e.g. with currency in their stored value account, with points in a loyalty program, by adding to a tab that the user is running with venue 102, and/or the like). The offer may comprise a limited time special offer. Central server 112 may be provided with similar ability to send out targeted messages to particular displays 104, particular remote interface units 14 and/or to main apparatus 12. Alternatively, or in addition, targeted messages may be broadcast to all displays 104 (and/or all remote interface units 14) in a venue, e.g. based on the behavior of one or more users in the venue. For example, if wagers on a particular track or in a particular region tend to be particularly popular at a given venue (e.g. wagers on tracks in Ireland), an advertisement for a resort or travel package in that region could be served to the displays 104 in the venue.

In the illustrated example embodiment, venue 102 includes one display 104 (TV #5) that is larger than the other displays 104 and may therefore be more desirable for viewing than the other displays 104. In some embodiments, the ability to control relatively more desirable display(s) 104 may be provided to one or more corresponding remote interface units 14 and/or to main apparatus 12. In the case of the illustrated FIG. 3 example, the ability to control TV #5 may be provided to a corresponding one of remote interface units 14 and main apparatus 12. The selection of which one of remote interface units 14 and main apparatus 12 gets to control TV #5 may be based on one or more of: the corresponding users' relative frequency of use of remote interface units 14 or main apparatus 12 to make wagers and/or other purchases (e.g. from venue 102), which may include one or both of frequency of wagers and/or purchases made in the user's current visit to venue 102 and frequency of wagers and/or purchases made over historical visits to venue 102 (e.g. over a configurable or predetermined historical temporal window); the corresponding users' relative amounts spent on wagering and/or making purchases (e.g. from venue 102) using remote interface units 14 or main apparatus 12, which may include one or both of amounts spent in the user's current visit to venue 102 and amounts spent over historical visits to venue 102 (e.g. over a configurable or predetermined historical temporal window); the corresponding users' relative winnings from wagers placed using remote interface units 14 or main apparatus 12; the relative amounts of the users' current wagers (i.e. on a race that is currently being broadcast or is about to be broadcast); and/or the like. Still other additional or alternative exemplary criteria for deciding which one of remote interface units 14 and main apparatus 12 get to control TV#5 include: apparatus 10 may give preference to certain users on the basis of points (or the like) in loyalty or reward system, whether or not one or more of the users in conflict have signed out or otherwise possess streaming-capable remote interface units 14, the number of users who have selected a particular race, and/or on other bases. The ability to control relatively more desirable sound systems (not shown) may be provided in a similar manner. In some embodiments, the ability to control relatively more desirable displays 104 and/or sound systems may be directly purchased or rented from venue 102—i.e. if a particular user wants to display their races on TV#5, then the user may rent some time to control TV#5.

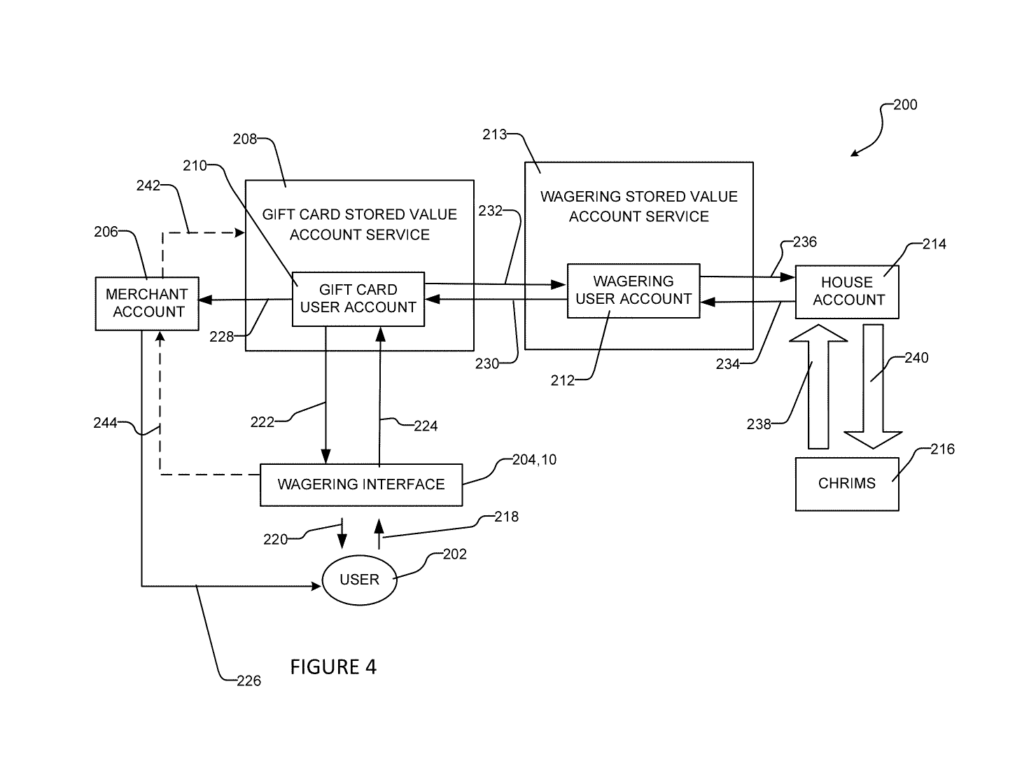

As discussed above, it may be desirable for apparatus 10 (and system 100) to make use of multiple levels of stored value accounts. FIG. 4 is a schematic illustration of an account system 200 which may be used in connection with apparatus 10 and system 100. Account system 200 of the illustrated embodiment makes use of a “gift card” stored value account service 208 and a separate wagering stored value account service 213. User 202 may deposit cash, credit/debit card or check into wagering interface 204 (e.g. apparatus 10 described above) as shown by arrow 218. This deposit may be used to fund a user gift card stored value account 210 with gift card stored value account service 208, as shown by arrow 224. In the case where user 202 uses their credit/debit card to fund their user gift card stored value account 210 (e.g. through main apparatus 12, remote interface unit 14 and/or any other suitable network enabled device, such as a computer, a smart phone, a point of sale debit/credit card device and/or the like), gift card stored value account service 208 may then access the funds from the financial institution (not shown) of user 202. Similarly, in the case where user 202 uses a check to fund their user gift card stored value account 210 (e.g. through main apparatus 12), gift card stored value account service 208 may access corresponding funds from a check-cashing organization, which check-cashing organization may interface with user 202 via main apparatus 12.

In some cases, a user can fund their user gift card stored value account 210 using cash which may be received by main apparatus 12. Where cash is received by or withdrawn from main apparatus 12, the proprietor of venue 102 may physically open main apparatus 12 to remove the deposited cash and/or to supply additional cash from time to time. At suitable intervals (e.g. daily, weekly or monthly), which may correspond to the intervals at which cash is withdrawn from apparatus 12 by the proprietor of venue 102, gift card stored value account service 208 may access a corresponding amount of funds from merchant account 206. In some embodiments, users can fund their user gift card store value account 210 indirectly through the proprietor of venue 102. For example, user 202 may make a payment to the proprietor of venue 102 via cash or credit/debit card, in which case, the proprietor of venue 102 may access the funds from the financial institution (not shown) of user 202. The proprietor of venue 102 can then add the amount of this payment to the user's gift card stored value account 210 using a different mechanism (e.g. a suitable electronic network-enabled interface, such as a computer, a smart phone, a point of sale debit/credit card device and/or the like (not shown)). Gift card stored value account service 208 can then withdraw the corresponding amounts from merchant account 206, if necessary.

In some embodiments (for example, some embodiments wherein credit card providers' prohibitions on gambling purchases are being accounted for), gift card stored value account 210 is not used directly for wagering. However, user gift card stored value account 210 may be used to make purchases from one or more merchants (e.g. the proprietor of venue 102 and/or any other merchant) as shown by arrow 228. The illustrated example embodiment of FIG. 4 shows only one merchant account 206, but it will be appreciated that system 200 may include two or more merchants, each of which may have their own account. When a user purchases goods or services (e.g. a beverage) from a merchant (e.g. the proprietor of venue 102) using their gift card stored value account 210, their gift card stored value account 210 is debited and the funds are transferred (e.g. by EFT, ACH transfer and/or the like) to merchant account 206 as shown at arrow 228. The goods and/or services may then be provided to user 202 as shown at arrow 226. In some embodiments, when a user purchases goods or services from a merchant, there may be a small payment (not shown) to gift card stored value account service 208. This payment may be a suitable fraction of the cost of the purchased goods and services and may be paid by the merchant (e.g. from merchant account 206) or by user 202 (e.g. from their gift card stored value account 210).

If a user wants to make a wager, then the user causes a transfer of funds from their gift card account 210 to a user wagering stored value account 212 with wagering stored value account service 213 as shown at arrow 232. The user's gift card account 210 is debited and their wagering account 212 is credited (e.g. by EFT, ACH transfer and/or the like). When user 202 places a wager (as discussed above), the details of the wager are recorded by apparatus 10 and the wagered funds may become the property of the “house”, as described above. This is shown by arrow 236, where funds are debited from user wagering account 212 and credited to house account 214 (e.g. by EFT, ACH transfer and/or the like). As discussed above, the transfer of funds from user wagering account 212 to house account 214 (shown by arrow 236) may occur in real time (e.g. as soon as the wagered amounts are recorded). In some embodiments, the transfer of funds out of user wagering account 212 may occur in real time (e.g. into an account (not shown) managed by wagering stored value account service 213) and may then be transferred from wagering stored value account service 213 to house account 214 at discrete times (e.g. daily, weekly or monthly).

From time to time (e.g. daily, weekly or monthly) a pari-mutuel wagering oversight body (e.g. CHRIMS Inc. and/or the like) 216 may request payment of these wagered amounts from the house and these wagered amounts will be transferred (e.g. by EFT, ACH transfer and/or the like) from house account 214 to the oversight body 216 as shown at arrow 240. From time to time (e.g. daily, weekly or monthly), oversight body 216 may then remit these wagered funds to the various stakeholders (e.g. race tracks, government bodies, content providers, winners and/or the like (not shown)) in the form of takeout or winnings FIG. 4 shows a payment from oversight body 216 to house account 214 at arrow 238. This transfer at arrow 238 (which may occur by EFT, ACH transfer and/or the like) includes the net takeout for the house based on wagers placed through house account 214 (e.g. wagers placed on apparatus 10 or via system 100) together with winnings on any such wagers.

If the race is run and user 202 loses, then nothing further happens to user wagering account 212 or user gift card account 210. However, if user 202 wins, this win is recorded and the funds are made available in user wagering account 212. In the illustrated embodiment of FIG. 4, the house transfers funds (e.g. by EFT, ACH transfer and/or the like) from its account 214 to user wagering account 212 in real time as shown at arrow 234. This is not necessary, however, and in some embodiments, wagering stored value service 213 may “front” the funds for user wagering account 212 and the transfer from house account 214 may be to wagering stored value service 213 generally and may occur at discrete times (e.g. daily, weekly or monthly). If user 202 wants, they can leave the funds in user wagering account 212 for placing further wagers. Alternatively, if user 202 wants to cash out or to make purchases of goods or services (other than wagers) from one or more merchants (e.g. the proprietor of venue 102), then user 202 may effect a transfer (e.g. by EFT, ACH transfer and/or the like) from their wagering account 212 to their gift card account 210 as shown by arrow 230. Then, if a user ultimately wants to cash out, they can debit their gift card account 210 (as shown notionally by arrow 222) and wagering device 204 (e.g. apparatus 10) will output cash to user 202 as shown at arrow 220. It is not necessary that user 202 cash out. A user may keep the funds in their gift card account 210 and/or their wagering account 212.

Just like user 202 can fund their gift card stored value account 210 through the proprietor of venue 202, in some cases, user 202 can cash out via the proprietor of venue 202. For example, user 202 can indicate to the proprietor of venue 102 that they would like to cash out. The proprietor of venue 102 can, for example, pay user 202 cash or deposit appropriate funds onto the user's credit/debit card. The proprietor of venue 102 can then deduct the amount of this payment from the user's gift card stored value account 210 using a different mechanism (e.g. a suitable electronic network-enabled interface, such as a computer, a smart phone, a point of sale debit/credit card device and/or the like (not shown)). Gift card stored value account service 208 can then credit the corresponding amounts to merchant account 206, if necessary.

Using stored value accounts (e.g. gift card account 210 and wagering account 212 or any other stored value accounts) may be effected by apparatus 10 using its card coder/printer 28 (see FIG. 2). Card coder/printer 28 may issue ID cards to users as discussed above, which will allow users to access their stored value accounts. Additionally, card coder/printer 28 may permit users to take their cashout (arrow 220 of FIG. 4) in the form of stored value gift cards. Such stored value gift cards may be provided with custom messages on the cards.

Apparatus 10, system 100 and/or venue 102 may provide a loyalty program, which may be implemented, for example, as a part of a user's gift card stored value account, as part of a user's wagering stored value account and/or as a separate account. Such a loyalty program may be administered, at least in part, by controller 16 (of apparatus 12), controller 38 (of remote interface unit 14), a controller (not expressly shown) associated with venue interface 110 and or a controller (not expressly shown) associated with remote server 112. Such a loyalty program may comprise, for example, awarding, recording and keeping track of loyalty points which may be redeemed for goods/services from merchants (e.g. the owner of venue 102 and/or other merchants, who may include strategic partners of the house and/or the like). By way of non-limiting example, loyalty points can be accumulated by: using remote interface units 14 and/or main apparatus 12; purchasing goods and/or service from merchants (e.g. from the owner of venue 102 and/or other merchants) via remote interface unit 14, main apparatus 12 or otherwise using an associated stored value account (e.g. a user's gift card stored value account 210 or wagering stored value account 212); placing wagers (e.g. via remote interface units 14, main apparatus 12 or otherwise); and/or the like. The number of loyalty points awarded may be based on factors including, by way of non-limiting example, any one or more of: amounts wagered; amounts won in wagers (e.g. net of amounts wagered or including amounts wagered); amounts lost in wagers (e.g. net of amounts wagered or including amounts wagered); the number or fraction of winning wagers; the number or fraction of losing wagers; the odds of wagers; amounts spent on the goods/services of the proprietor of venue 102; amounts spent on goods/services of merchants who are partners of the house; and/or the like. In some embodiments, the number of loyalty points awarded may be based on a temporal rate of any of these factors—e.g. amounts wagered per unit time.

It will be appreciated that more wagering and/or more purchasing of goods/services typically leads to a correspondingly greater accumulation of points. In some embodiments, winning more wagers also leads to a correspondingly greater accumulation of points. However, in some embodiments, points (or a relatively large number of points) can additionally or alternatively be awarded for amounts lost or rates of loss, which may help to make users feel better about their losses. For example, if the amount lost by a user on a particular day is over a threshold amount, then the user may be awarded bonus loyalty points over and above what they might have earned on the basis of wagers placed.

In some embodiments, loyalty points can be accumulated at different rates depending on a user's membership level. For example, a loyalty program may have a bronze level (where points are accumulated at a rate x), a silver level (where points are accumulated at a rate αx, where α>1) and a gold level (where points are accumulated at a rate βx, where β>α). In general, a loyalty program may have any suitable number of levels and the point accumulation coefficients (e.g. α, β, . . . ) can be appropriately configured for each level. In some embodiments, a particular user's level within the loyalty program may be determined by an annual fee. For example, the bronze level membership may be free, the silver level membership may involve an annual fee of $50 and the gold level membership may involve an annual fee of $100. In some embodiments, however, a particular user's level within the loyalty program may be influenced by one or more other factors which include, by way of non-limiting example, any one or more of: the number of points that a user has accumulated (e.g. possibly disregarding any point redemptions) in aggregate and/or per unit time; the duration of time that the user has been a member of the loyalty program; the number of points that the user has redeemed in aggregate and/or per unit time; and/or the like.

In some embodiments, system 100 (and similar systems at other venues) may permit different types of wagering opportunities which may increase user interest and which may correspondingly increase wagered amounts, wagering frequency and/or house take. For example, groups of users within a venue 102 (and/or at geographically distinct venues) may form teams, whose winnings and, optionally, losses may be aggregated using a suitable “team-wager-success” metric to compete against other teams in a team-based wagering opportunity. Such teams may be formed for wagering opportunities on a day-by-day basis, game-by-game basis (e.g. where a game may last an evening, a suitable period of time (e.g. 1-3 hours), a suitable number or series of wagers (e.g. over ten bets, and/or the like), over a suitable number or series of events (e.g. ten horse races, over an NBA basketball game, over the NFL playoffs and/or the like), over longer periods of time (e.g. over a month or a year), over longer series of events (e.g. over a NBA season) and/or the like.

One or more teams (or the members of one or more teams) that have a relatively high team-wager-success metric at the end of the game (and/or during the game after some suitable temporal-based, or event-based, trigger) may be provided with incentive awards—e.g. incentive awards may be given to the members of the first place team, the top three teams and/or the like. Non-limiting examples of such incentive awards comprise: non-monetary incentive awards, such as coupons, gift or stored value cards (which may be printed by coder/printer 28), loyalty points and/or the like which may be redeemable by team members for goods/services at venue 102 or for goods/services of other merchants who may be strategic partners of the house; monetary incentive awards, such as bonus payouts into the wagering accounts and/or gift card accounts of the team members; and/or the like. Incentive awards may be additionally or alternatively given out on the basis of criteria other than the team-wager-success metric. By way of non-limiting example, similar incentive awards may be provided at the end of the game (and/or during the game after some suitable temporal-based, or event-based, trigger) for teams with relatively high total amounts wagered, relatively high average amounts wagered (e.g. per team member), relatively high total winnings, relatively high average winnings (e.g. per team member). In some embodiments, system 100 (and similar systems in other venues) may provide teams of users with feedback which may help the team to improve its handicapping strategies. Such feedback may be tailored based on the wagers made by the members of a particular team.

The team-wager-success metric may be based on a variety of factors, including, by way of non-limiting example, any one or more of: the amounts wagered by members of the team on qualifying wagers; the amounts won in qualifying wagers placed by members of the team (e.g. net of amounts wagered or including the amount wagered); the amounts lost in qualifying wagers placed by members of the team (e.g. net of amounts wagered or including the amount wagered); the number or fraction of winning qualifying wagers placed by members of the team; the number or fraction of losing qualifying wagers placed by members of the team; the odds of qualifying wagers placed by members of the team; and/or the like. In some embodiments, the team-wager-success metric may be based on a temporal rate of any of these factors—e.g. amounts of qualifying wagers by members of the team per unit time and/or per event. Any one or more of these factors based on members of the team may used to create a corresponding member-wager-success metric for each member of a team and the member-wager-success metrics for the team members be combined (e.g. added or averaged) to get a team-wager-success metric. Individual team member weightings may be assigned to such combinations—e.g. team member A may be a captain of the team and may therefore have extra weight applied to any factors based on wagers placed by team member A (or to the member-wager-success metric of team member A) relative to his or her teammates. Additionally, or alternatively, a team may place wagers as a team in which case the factors involved in computing the team-wager-success metric may be additionally or alternatively based on team wagers (as opposed to the wagers of individual members).

In one particular exemplary embodiment, the team-wager-success metric is based on a combination (e.g. a sum or average) of the member-wager-success metrics of its team members and each team member's member-wager-success metric is given by:

MWSM=Win_{frac}*Win_{$} (1)

where:

$$\begin{matrix}{Win}_{frac} = \frac{\# of qualifying wagers won}{total \# of qualifying wagers} \\ and & ( 2 ) \\ {Win}_{\$} = gross accumulated winnings on winning wagers & ( 3 )\end{matrix}$$

In this formulation: MWSM represents the member-wager-success metric; Win_{frac} represents the fraction of the number of qualifying wagers where the member wins over the total number of qualifying wagers placed by the member; and Win_{$} represents the gross accumulated winnings on qualifying wagers placed by the member. In some embodiments, the gross winnings Win_{$} is not netted for losses. For example, if a member bets $10 and wins $9, then Win_{$} increases by $9 even though the bet effectively lost $1. Similarly, the gross winnings Win_{$} may include wagered amounts. For example, if a member best $10 and wins $15 (including the $10 wager), then Win_{$} increases by $15.

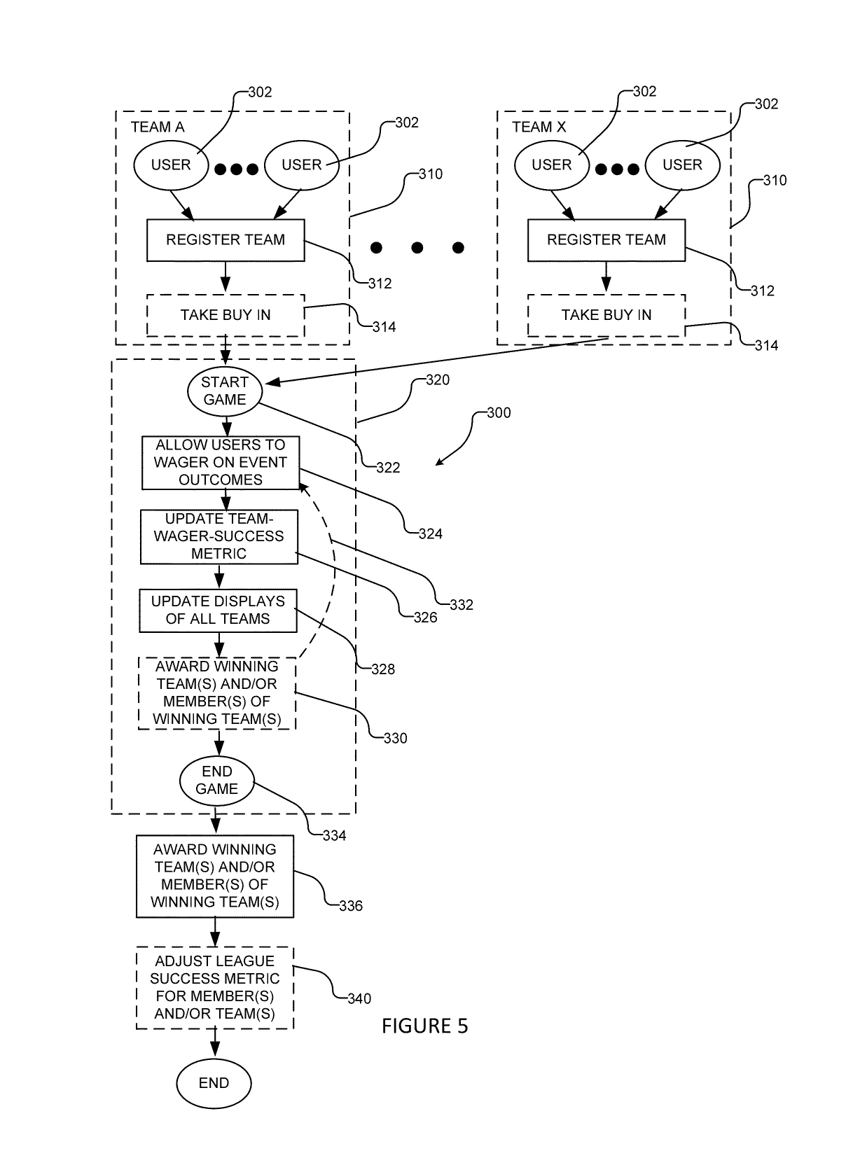

FIG. 5 shows a schematic depiction of a method 300 for implementing a team-based wagering opportunity according to a particular embodiment of the invention. Method 300 (and other similar wagering opportunity methods described herein) may be implemented, at least in part, by controller 16 of apparatus 10, by controller 32 of a remote interface unit 14, by a controller (not expressly shown) associated with venue interface 110 and/or by a controller (not expressly shown) associated with remote server 112. Data relating to horses, races, tracks and/or the like that is used in method 300 may be sourced by such controllers from WAN 44 (e.g. the internet) or by any other suitable technique. In some embodiments, such data (or portions thereof) may be cached (e.g. at suitable time intervals) so that it is available to method 300 (and/or other similar methods) and to apparatus 10, remote interface devices 14 and/or the remote server 112).

Method 300 commences when users 302 decide to join together to form teams 310. In some embodiments, it is envisaged that each team 310 might be made up of members 302 who are located at (or regulars of) a particular venue 102 having a system 100 (like that described herein). This is not necessary. In some embodiments, members 302 of a team 310 may be located at different venues or different geographical locations and individual members can participate via remote interface units 14. In some embodiments, multiple teams (or at least some of the members 302 of multiple teams 310) can be located in a single venue 102. In currently preferred embodiments, each user who is a member 302 of a team 310 creates (or has previously created) accounts with apparatus 10 and/or system 100 as described above, although in some embodiments, this may not be necessary. In general, a team may have any desirable number of members 302.

Once team members 302 are in place, a team 310 may be registered in block 312. The block 312 registration may involve, for example, creating a team identification (e.g. a team name) and providing the particulars (e.g. the ID and account information) of team members 302. This block 312 information may be input, for example, by a user (typically one of the members 302 of a team 310) interacting with system 100 (e.g. by the user interface of one of main apparatus 12 and/or one of remote interface units 14 which may be referred to collectively or individually as network-enabled wagering interface(s)). The block 302 registration information may be communicated via WAN 44 to a remote server 112, which may administer central or global functionalities of team-based wagering opportunity 300, such as the particulars of various participating teams 310, for example. In some embodiments, the block 312 information could be input and communicated to remote server 112 using another type of network-enabled device, such as a general purpose computer and/or the like. In general, team-based wagering opportunity 300 requires two or more participating teams 310, but may comprise any suitable number of teams 310 greater than or equal to two. In the illustrated embodiment, two teams 310 (Team A and Team X) are shown for explanatory purposes only. Block 312 may optionally involve creating team stored value accounts—e.g. a team gift card stored value account and/or a team wagering stored value account, similar to the accounts described above. This is not necessary, however, and method 300 may involve interacting directly with the accounts of team members 302.

In block 314, method 300 optionally involves procuring a buy-in from each registered team 310. This block 314 buy-in may be debited from the team wagering account (if it exists) or from the wagering accounts of one or more of each team's members 302—e.g. equally from the wagering accounts of each team member 302. These block 314 buy-ins may be temporarily credited to a house account (e.g. house account 214 in FIG. 4). The block 314 buy-in is not necessary. In some embodiments, block 314 is omitted. The block 314 buy-in may be effected by suitable communication among the network-enabled wagering interfaces of team members 302, remote server 112 and any server(s) associated with maintaining the accounts of team members 302.

Team-based wagering opportunity 300 shown in the FIG. 5 embodiment takes place over a “game” or “tournament” 320, which defines the parameters of the wagers that count toward team-based wagering opportunity 300 (referred to as qualifying wagers). As mentioned above, game 320 may define a game period which may comprise a temporal period (e.g. a period of 1 day or 2 hours), a suitable number or series of wagers (e.g. over one hundred wagers or ten wagers), a suitable number or series of events (e.g. one hundred horse races or ten horse races) and/or the like. While generally speaking game 320 is capable of permitting any type of wager that can be facilitated by system 100 and/or apparatus 10, game 320 may limit the parameters of qualifying wagers. By way of non-limiting example: game 320 may only permit wagers to be placed on the races at one or two particular tracks (e.g. tracks selected by the house because they have relatively high net takeout rates); game 320 may only permit wagers of a particular type (e.g. exacta races or other multi-participant races that have relatively high net takeout rates); and/or the like.

Once the teams 310 are registered, game 320 begins in block 322. In block 324 individual members 302 of teams 310 are permitted to place qualifying wagers on event outcomes using their network-enabled wagering interfaces (e.g. main apparatus 12, remote interface units 14 or apparatus 10 generally). While members 302 may also place non-qualifying wagers in the normal course (as discussed above), only wagers which qualify for game 320 will count towards team-based wagering opportunity 300. Members 302 of a single team 310 are not required to place block 324 qualifying wagers that conform with one another—that is, members 302 of a single team 310 may place qualifying wagers that are independent of one another, which may be based on completely different events or event types and which may even oppose one another. For example, one team member 302 may place a qualifying wager on race #1 at track X, while another team member 302 of the same team 310 places two qualifying wagers—one on race #8 at track Y and one on an NFL game. Other than for counting toward team-based wagering opportunity 300, a qualifying wager made by a team member 302 in block 324 can be treated in the same manner as discussed herein for general pari-mutuel wagers. That is, the wager is placed by team member 302 via interaction with a network-enabled wagering interface, the member's wagering account 212 (FIG. 4) may be debited upon placing the wager and credited if the wager wins. Block 324 wagers may be communicated via WAN 44 to a remote server 112, which may keep track of the block 324 qualifying wagers for each member 302 and the corresponding results of the block 324 qualifying wagers.

Upon discerning the outcome of each block 324 qualifying wager placed by any member 302 of any team 310, method 300 involves updating the corresponding team's team-wager-success metric in block 326 (and the corresponding team member's member-wager-success metric). Block 326 may be performed by remote server 112 based on its knowledge of the block 324 qualifying wagers and the particulars of teams 310 and members 302. In some embodiments, as discussed above, updating a team-wager-success metric in block 326 may also involve updating the member-wager-success metrics of the individual members 302 of the team 310 and, in particular, any members 302 of any team 310 who wagered on the most recent event outcome. In one particular exemplary embodiment, the block 326 member-wager-success metric may be determined in accordance with equations (1)-(3) described above and the block 326 team-wager-success metric may be updated by combining (e.g. adding or averaging) the updated member-wager-success metrics. In general, however, the block 326 team-wager-success metrics may be updated based on any of the factors discussed above. Member-wager-success metrics and team-wager-success metrics may be maintained by remote server 112.

Method 300 then proceeds to block 328 which involves updating the displays of all teams 310 to reflect the block 326 updated team-wager-success metrics and, optionally, the block 326 member-wager-success metrics. Block 328 may involve communicating updated team-wager-success metrics and, optionally, member-wager-success metrics to network-enabled wagering interfaces operated by individual members 302 and/or to displays 104 in venues 102 that can be seen by multiple members 302 of teams 310. The block 328 display update can increase competition levels between teams 310 (e.g. if two or more teams 310 are relatively close in team-wager-success metric), which may in turn inspire increased wagering and increased revenue for the house. Method 300 may then proceed to optional block 330 which involves (upon the occurrence of some suitable temporal-based or event-based trigger that occurs part-way through game 320) awarding winning team(s) 310 (e.g. one or more team(s) with relatively high team-wager-success metrics) with corresponding incentive awards which may comprise non-monetary incentive awards, monetary incentive awards and/or the like, as discussed above. While these block 330 incentive awards are based on team performance, the block 330 incentive awards may be provided to the individual team members 302—e.g. adding loyalty point to the loyalty points accounts of team members 302, adding dollars to the wagering accounts of individual team members 302 and/or the like. The administration of the block 330 incentive awards may be handled by remote server 112 which may communicate with the network-enabled wagering interfaces of team members 302 and/or server(s) administrating the accounts of team members 302.

The block 330 incentive awards may additionally or alternatively be given out on the basis of criteria other than team-wager-success metrics, as discussed above. The block 330 incentive awards may be given out to one team, more than one team or to no teams (e.g. if no teams meet a threshold team-wager-success metric and/or a threshold amount wagered on qualifying wagers). In some embodiments, the amounts of the incentive awards administered in block 330 may be based, at least in part, on the team-wager-success metric(s) of the team(s) 310 to which incentive awards are provided. In some embodiments, block 330 may additionally or alternatively involve providing incentive awards to individual team members 302 (e.g. to one or more individual team members 302 having relatively high member-wager-success metrics). Any such incentive awards provided to individual team members 302 in block 330 may have characteristics similar to the block 330 team based awards described herein, but suitably modified for individuals. For example, the amount of the individual incentive awards administered in block 330 may be based, at least in part, on the member-wager-success metric.

The functional blocks 324, 326, 328, 330 of game 320 are preferably performed in real time, such that increased competition (and correspondingly increased wagering) are inspired as between teams 310 and team members 302. This real time updating is schematically depicted in FIG. 5 by arrow 332 which loops back to block 324 to indicate that the procedures of blocks 324, 326, 328 and 330 may be repeated many times during game 320. As discussed above, game 320 has some boundaries and eventually comes to an end at the conclusion of the game period in block 334, whereupon method 300 proceeds to block 336.

In block 336, method 300 involves awarding winning team(s) 310 (e.g. one or more team(s) 310 with relatively high team-wager-success metrics) with corresponding incentive awards which may comprise non-monetary incentive awards, monetary incentive awards and/or the like, as discussed above. In general, the procedures and incentive awards of block 336 may be the same as those of block 330 discussed above, except that the incentive awards of block 336 are the final incentive awards and may be larger (e.g. in value) than the block 330 interim incentive awards. Like the incentive awards administered in block 330 discussed above, some block 336 incentive awards may be administered to individual team members 302. In addition to awarding the incentive awards, block 336 may optionally involve disbursing any block 314 buy-in amounts to the winning team(s) 310. The winning team(s) 310 to which the block 314 buy-in amounts are disbursed may be determined on the same or similar criteria to those of the block 336 (and block 330) incentive awards (e.g. team-wager-success metrics). In some embodiments, where permitted by applicable regulations, the house may take-out a portion of the total buy-in pool as a take-out or payment to the house, prior to the buy-in pool being disbursed in block 336. In some embodiments, the buy-in pool may be disbursed to a single team 310; in some embodiments, the buy-in pool may be disbursed to multiple teams 310 (e.g. to the first, second and third placed teams 310). As is the case of the incentive awards discussed above, the block 336 buy-in disbursement is a team award, but it may be disbursed into the wagering accounts of the individual team members 302. In some embodiments, a portion of the buy in disbursement may be disbursed to individual team members 302 who have relatively high member-wage-success metrics (e.g. the top three members 302 from across all teams). Like block 330 discussed above, the administration of the block 336 incentive awards and buy-in disbursement may be handled by remote server 112 which may communicate with the network-enabled wagering interfaces of team members 302 and/or server(s) administrating the accounts of team members 302.

Method 300 may then proceed to optional block 340, which involves adjusting a league-success metric for individual team members 302 and/or for teams 310. Block 340 may be performed by remote server 112. Block 340 contemplates that an individual member 302 and/or a team 310 may be part of a “league” which involves a plurality of wagering opportunities, each of which is similar to the FIG. 5 wagering opportunity 300. By way of non-limiting example, such a league could be based on a series of weekly races at a particular track (each week providing a wagering opportunity similar to wagering opportunity 300), a series of weekly timed team-events (each week providing a wagering opportunity similar to wagering opportunity 300) and/or the like. In such leagues it may be desirable for individual team members 302 and/or teams 310 to keep track of a “league-success metric” which ranks individual team members 302 and/or teams 310 against other individuals or teams over the duration of the league.

Such a league-success metric (and/or the amount by which it is updated in block 340) may be based on any of the factors or criteria discussed above for the team-wager-success metrics and/or member-wager-success metrics. Such a league-success metric (and/or the amount by which it is updated in block 340) may additionally or alternatively be based on characteristics of the wagering opportunities in which an individual team member 302 or team 310 takes part. For example, the amount by which a league-success metric is updated in block 340 at the conclusion of wagering opportunity 300 may be based on any one or more of: the number of competing teams 310 in wagering opportunity 300 (e.g. a relatively large number of competing teams 310 in wagering opportunity 300 corresponding to a relatively large block 340 increase in the league-success metric); the team-wager-success metrics of the competing teams 310 in wagering opportunity 300 (e.g. a relatively large average team-wager-success metric among the teams 310 in wagering opportunity 300 indicating a relatively high level of competition and corresponding to a relatively large block 340 increase in the league-success metric); and/or the like.

The league-success metric updated in block 340 may be used as a basis for awarding incentive awards and/or disbursing buy-in pools in a league-based wagering opportunity (not expressly shown) which comprises a plurality of wagering opportunities similar to wagering opportunity 300. Such a league-based wagering opportunity may be similar in many respects to method 300. For example, such a league-based wagering opportunity may involve setting up teams 310 in a manner similar to method 300, except that there may an additional optional buy-in (similar to block 314) for the league itself. Such a league-based wagering opportunity may also be similar to method 300 in the sense that such a league-based wagering opportunity may comprise functional blocks similar to blocks 314 through 340 for each of a plurality of individual wagering opportunities and then may involve repeating blocks 314 through 340 over a number of iterations to provide the league. At the conclusion of the league (e.g. at the conclusion of the plurality of iterations of blocks 314 through 340), such a league-based wagering opportunity may comprise awarding incentive awards and/or disbursing the league buy-in pool to one or more team(s) 310 and/or individual(s) 302 with the highest (team and/or member) league-success metric. Such awarding of incentive awards and/or disbursing of the league buy-in pool may be similar to the awarding of incentive awards and/or the disbursing of the block 314 buy-in pool in block 336 of method 300 as described above.

Wagering opportunity 300 of the FIG. 5 embodiment is a team-based wagering opportunity where teams 310 may compete against one another. Wagering opportunity 300 could be modified to permit individuals to compete against one another. Such a modification would involve, inter alia, registering a single user in block 312, optionally taking individual (as opposed to team) buy-ins in block 314, updating a single-user-wager-success metric (which could be substantially similar to member-wager-success metrics discussed above) in block 326 as opposed to updating a team-based metric, updating displays of individual users in block 328 as opposed to updating team-based displays, awarding one or more winning individuals (as opposed to teams) in blocks 330 and 336 wherein such rewards could be based on individual metrics (such as the single-user-wager-success metric) as opposed to team-based metrics and optionally updating individual league-success metrics in block 340 (as opposed to team-based league-success metrics).

For an individualized version of wagering opportunity 300, individual league-success metrics (and/or the amount by which it is updated in the modified version of block 340) may be based on any of the factors or criteria discussed above for the member-wager-success metrics. Such an individual league-success metric (and/or the amount by which it is updated in the modified version of block 340) may additionally or alternatively be based on characteristics of the wagering opportunities in which an individual takes part. For example, the amount by which an individual league-success metric is updated in the modified version of block 340 at the conclusion of a wagering opportunity may be based on any one or more of: the number of competing individuals the wagering opportunity (e.g. a relatively large number of competing individuals in a wagering opportunity corresponding to a relatively large block 340 increase in the individual league-success metric); the individual-user-wager-success metrics of the competing individuals in a wagering opportunity (e.g. a relatively large average individual-user-wager-success metric among the individuals in a wagering opportunity indicating a relatively high level of competition and corresponding to a relatively large block 340 increase in the individual league-success metric); and/or the like.

In some embodiments, users (or teams of users) could create competitive fantasy groups of trainers, jockeys, owners, horses and/or the like and these users could have their fantasy group compete against the fantasy groups of other users. For example, each user could pick (or draft) a fantasy group of ten jockeys. Scores could be kept on the basis of the total combined purses won by the group of jockeys over a suitable period of time (e.g. six months, a year and/or the like) or a suitable series of events (e.g. ten races, a racing season and/or the like). Similar fantasy groups could be based on trainers, owners, horses and/or the like. One or more users that have a relatively high (e.g. first place, top three and/or the like) fantasy group score at the end of the fantasy game (and/or over some suitable temporal-based, or event-based, portion of the fantasy game) may be provided with incentives similar to those discussed above for team play.

In some embodiments, system 100 permits a user to place wagers that are the same (except possibly for the amount wagered) as an “expert”. Such an “expert” could be an experienced handicapper and his/her wagers could be published on system 100 so that a user can decide whether they want to place the same wagers as the “expert”. In some embodiments, the expert need not be a true “expert” and can be the friend of a user or any other user.

As discussed above, the instantaneous odds of a pari-mutuel wager can change over time. In particular embodiments, system 100 may permit a user to configure their wagering preferences to automatically place or cancel (or increase or decrease) wagers based on the changing odds (e.g. the odds changing from below an odds-based threshold to above the threshold or from above an odds-based threshold to below the threshold). For example, system 100 may permit a user to configure a wager to be automatically placed or withdrawn (or increased or decreased) by way of a limit-odds wager—i.e. where the wager is automatically placed or withdrawn (or increased or decreased) provided that the odds are greater than or less than an odds-limit threshold, but their wager is automatically reversed if the odds transition past the odds-limit threshold. Similarly, system 100 may permit a user to configure a wager to be automatically placed or withdrawn (or increased or decreased) based on a stop-odds wager—i.e. where the wager is automatically placed or withdrawn (or increased or decreased) if the odds transition past an odds-stop threshold. Similarly, system 100 may permit a user to configure a wager to be automatically placed or withdrawn based on a stop-limit-odds wager. Such a stop-limit-odds wager involves an odds-stop threshold and an odds-limit threshold. Such a stop-limit-odds wager may take a number of forms. For example, a wager may be automatically placed if the odds transition past an odds-stop threshold and then automatically withdrawn if the odds transition past an odds-limit threshold. As another example, a wager may be automatically withdrawn if the odds transition past an odds-stop threshold and then automatically re-placed if the odds transition past an odds-limit threshold. As still another example, a wager may be automatically placed when the odds transition past an odds-stop threshold and then automatically increased or decreased if the odds transition past an odds-limit threshold. Automatic wagering involving such odds-based thresholds may be combined with other forms of handicapping.

In embodiments where handicapping strategies are user configurable or where any other parameters (e.g. automatic placement or withdrawal of wagers based odds-stop thresholds or odds-stop-limit thresholds) described herein are user-configurable, then a particular user's preferences may be recorded by system 100, so that they do not have to be re-entered for each wager.

Certain implementations of the invention comprise computer processors which execute software instructions which cause the processors to perform one or more methods of the invention. For example, the methods described herein may be implemented by one or more processors which execute software instructions which cause the processor to perform these methods. Such software instructions may be retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

While a number of exemplary aspects and embodiments are discussed herein, those of skill in the art will recognize certain modifications, permutations, additions and sub-combinations thereof. For example:
The above-discussed embodiments primarily describe horse racing, which is merely an example of an event where a pari-mutuel style wager may be placed on an outcome of the event. It will be appreciated that the above-described methods, systems and apparatus could be similarly applied to dog racing or other forms of racing where pari-mutuel wagering is performed or, more generally, to any type of event on which a pari-mutuel wager can be placed on an outcome of the event. By way of non-limiting example, the methods, systems and apparatus described herein could be used for wagering in connection with motor car races, outcomes associated with sporting games or events (such as, by way of non-limiting example, who will score the next goal or touchdown, whether a particular team will score more than X points in a game, whether a particular team will concede more than Y turnovers in a game and/or the like), the outcomes of democratic elections, the results of a company's quarterly earnings release, and other binary outcomes determined by a third party event that the user normally has no influence over.
When a user is interacting with apparatus 12, apparatus 12 may printout coupons, special offers and/or the like (e.g. via receipt printer 17 or booklet printer 19). Such coupons and special offers may be based on information that system 100 has about the particular user's behavior in a manner similar to the messages output to remote device interfaces 14 and/or to displays 104 discussed above.
In some embodiments, apparatus 10 (including main apparatus 12 and/or remote device interfaces 14) and/or system 100 may be configured to inquire into (or predict) a user's approximate wagering loss limit and may take some action to help a user feel better. Such action(s) may include, by way of non-limiting example: loyalty reward bonus points, a loyalty reward gift (e.g. a free drink), a positive message and/or the like.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for providing a team-based wagering opportunity, the method comprising:
providing a plurality of teams, each team comprising one or more team members;
permitting each team member to make one or more qualifying wagers on one or more outcomes of one or more events during a game period using a network-enabled wagering interface for communicating the qualifying wagers over a communication network;
tracking a member-wager-success metric for each team member of each team and a team-wager-success metric for each team, each team-wager-success metric based on a combination of the member-wager-success metrics of its corresponding team members;
for each qualifying wager made by each team member during the game period, updating the member-wager-success metric of the team member based on one or more characteristics of the qualifying wager and updating the team-wager-success metric of the team to which the team member belongs based on the updated member-wager-success-metric;
at a conclusion of the game period, awarding incentive awards to the team members of at least one team having a highest team-wager-success metric.

2. A method according to claim 1 wherein permitting each team member to make one or more qualifying wagers on one or more outcomes of one or more events during the game period comprises permitting a plurality of team members of one of the plurality of teams to make qualifying wagers independently of one another.

3. A method according to claim 1 comprising permitting each team member to make one or more non-qualifying wagers on one or more outcomes of one or more events during the game period using the network-enabled wagering interface for communicating the qualifying wagers over the communication network; and wherein results of non-qualifying wagers do not impact the team member's member-wager-success metric or the team-wager-success metric of the team member's team.

4. A method according to claim 1 comprising, for each qualifying wager made by each team member during the game period: debiting a wagering account of the team member by a corresponding wager amount; and crediting the wagering account of the team member within winnings from the qualifying wager if the qualifying wager is successful.

5. A method according to claim 1 wherein the one or more team members of at least two of the plurality of teams are located at geographically distinct venues.

6. A method according to claim 1 wherein the game period comprises a temporal game period which includes a plurality of different events on which team members can make qualifying wagers.

7. A method according to claim 6 wherein the plurality of different events comprises a plurality of different event types.

8. A method according to claim 1 wherein the game period comprises a predetermined plurality of events on which user can make qualifying wagers.

9. A method according to claim 1 comprising, for each team, determining the team-wager-success metric based on a sum of the member-wager-success metrics of team members belonging to the team.

10. A method according to claim 1 comprising, for each team, determining the team-wager-success metric based on a weighted sum of the member-wager-success metrics of team members belonging to the team, wherein the member-wager-success metrics of some team members belonging to the team are weighted differently than the member-wager-success metrics of other team members belonging to the team.

11. A method according to claim 9 comprising, for each team, determining the team-wager-success metric based on the sum of the member-wager-success metrics of team members belonging to the team divided by the number of team members belonging to the team.

12. A method according to claim 1 wherein updating the member-wager-success metric of the team member based on one or more characteristics of the qualifying wager comprises updating the member-wager-success metric of the team member based on an amount of the wager.

13. A method according to claim 1 wherein updating the member-wager-success metric of the team member based on one or more characteristics of the qualifying wager comprises updating the member-wager-success metric of the team member based on an amount won in the wager, net of an amount wagered or including the amount wagered.

14. A method according to claim 1 wherein updating the member-wager-success metric of the team member based on one or more characteristics of the qualifying wager comprises updating the member-wager-success metric of the team member based on an amount lost in the wager, net of an amount wagered or including the amount wagered.

15. A method according to claim 1 wherein updating the member-wager-success metric of the team member based on one or more characteristics of the qualifying wager comprises updating the member-wager-success metric of the team member based on a number or fraction of winning qualifying wagers placed by the team member during the game period.

16. A method according to claim 1 wherein updating the member-wager-success metric of the team member based on one or more characteristics of the qualifying wager comprises updating the member-wager-success metric of the team member based on a number or fraction of losing qualifying wagers placed by the team member during the game period.

17. A method according to claim 1 wherein updating the member-wager-success metric of the team member based on one or more characteristics of the qualifying wager comprises updating the member-wager-success metric of the team member based on odds associated with the qualifying wager.

18. A method according to claim 1 wherein awarding incentive awards to the team members of the at least one team having the highest team-wager-success metric comprises electronically crediting stored value accounts of the team members of the at least one team.

19. A method according to claim 1 wherein awarding incentive awards to the team members of the at least one team having the highest team-wager-success metric comprises issuing loyalty points in a loyalty program to the team members of the at least one team.

20. A method according to claim 19 wherein the loyalty points are redeemable for goods or services of a venue in which at least one team member of the at least one team is located during the game period.

21. A method according to claim 1 wherein awarding incentive awards to the team members of the at least one team having the highest team-wager-success metric comprises awarding a gift card redeemable for goods or services other than wagering goods or services.

22. A method according to claim 1 comprising, prior to permitting each team member to make one or more qualifying wagers, extracting a buy-in payment from each team to form a buy-in pool.

23. A method according to claim 22 wherein extracting the buy-in payment comprises debiting a stored value account of each team member of each team.

24. A method according to claim 22 comprising, at the conclusion of the game period, disbursing at least a portion of the buy-in pool to the team members of the at least one team having the highest team-wager-success metric.

25. A method according to claim 22 comprising providing a house portion of the buy-in pool to a party administering the wagering opportunity.

26. A method according to claim 1 comprising, upon an occurrence of a trigger prior to the conclusion of the game period, awarding interim incentive awards to the team members of at least one team having a highest team-wager-success metric at the time of the trigger.

27. A method according to claim 26 wherein awarding the interim incentive awards to the team members of the at least one team having the highest team-wager-success metric at the time of the trigger comprises electronically crediting stored value accounts of the team members of the at least one team.

28. A method according to claim 26 wherein awarding the interim incentive awards to the team members of the at least one team having the highest team-wager-success metric at the time of the trigger comprises issuing loyalty points in a loyalty program to the team members of the at least one team.

29. A method according to claim 1 comprising, at the conclusion of the game period, adjusting a league-success metric for each of the team members of the at least one team having the highest team-wager-success metric, the league-success metric of each team member indicative of a wagering aptitude of the team member over a plurality of game periods.

30. A method according to claim 29 comprising, at the conclusion of a league comprising a plurality of game periods, awarding an incentive award to at least the team member having a highest league-success metric.

31. A method according to claim 1 comprising, at the conclusion of the game period, adjusting a league-success metric for the at least one team having the highest team-wager-success metric, the league-success metric of the at least one team indicative of a wagering aptitude of the members of the team over a plurality of game periods.

32. A method according to claim 31 comprising, at the conclusion of a league comprising a plurality of game periods, awarding an incentive award to the team members of the at least one team having a highest league-success metric.

33. A method according to claim 1 comprising, at the conclusion of the game period, awarding an incentive award to a team member of any team having a highest member-wager-success metric.

34. A method according to claim 22 comprising, at the conclusion of the game period, disbursing at least a portion of the buy-in pool to a team member of any team having a highest member-wager-success metric.

35. A system for providing a team-based wagering opportunity for a plurality of teams, each team comprising one or more team members and each team member having access to a network-enabled wagering interface useable by the team member to make pari-mutuel wagers on outcomes of events over a communication network, the system comprising:
a processor in communication with the network-enabled wagering interfaces via the communication network, the processor configured to:
communicate with the network-enabled wagering interfaces to permit each team member to use their network-enabled wagering interface to make one or more qualifying wagers one or more outcomes of one or more events during a game period;
track a member-wager-success metric for each team member of each team and a team-wager-success metric for each team, each team-wager-success metric based on a combination of the member-wager-success metrics of its corresponding team members;
for each qualifying wager made by each team member during the game period, update the member-wager-success metric of the team member based on one or more characteristics of the qualifying wager and update the team-wager-success metric of the team to which the team member belongs based on the updated member-wager-success-metric;
at a conclusion of the game period, award incentive awards to the team members of at least one team having a highest team-wager-success metric.

36. A system for placing pari-mutuel wagers, the system comprising a processor in communication with a user interface and a network, the processor configured to:
receive a user identification via the user interface;
determine a points account associated with the user based on the user identification;
receive, from the user via the user interface, a wager corresponding to an outcome of a selected event; and
in response to receiving the wager from the user:
place the wager on the selected event; and
credit the points account with a corresponding loyalty point amount, the corresponding loyalty point amount based at least in part on a characteristic of the wager;
wherein the characteristic of the wager comprises the user's number or fraction of winning wagers.

37. A system according to claim 36 wherein the characteristic of the wager comprises an amount of the wager.

38. A system according to claim 36 wherein the characteristic of the wager comprises an amount won in the wager, net or inclusive of an amount wagered.

39. A system according to claim 36 wherein the characteristic of the wager comprises an amount lost in the wager, net or inclusive of an amount wagered.

40. A system according to claim 36 wherein the characteristic of the wager comprises the user's number or fraction of losing wagers.

41. A system according to claim 36 wherein the characteristic of the wager comprises whether the user's wagering losses in a given time period are greater than a threshold.

42. A method for placing pari-mutuel wagers, the method comprising:
receiving a user identification from a user via a network-enabled wagering interface;
determining a points account associated with the user based on the user identification;
receiving, from the user, via the network-enabled interface, a wager corresponding to an outcome of a selected event; and
in response to receiving the wager from the user:
placing the wager on the selected event; and
crediting the points account with a corresponding loyalty point amount, the corresponding loyalty point amount based at least in part on a characteristic of the wager;
wherein the characteristic of the wager comprises the user's number or fraction of winning wagers.
